(19) United States
(12) Patent Application Publication
(10) Pub. No.: US 2003/0067160 A1
(43) Pub. Date: Apr. 10, 2003

(54) System for detachable connection of a first and a second tube element

(76) Inventor: Charles Vincent Wenck, Bro (SE)

Correspondence Address: JACOBSON HOLMAN PLLC, 400 SEVENTH STREET N.W., SUITE 600, WASHINGTON, DC, 20004, US

(21) Appl. No.: 10/261,683

(22) Filed: Oct. 2, 2002

(30) Foreign Application Priority Data
Oct. 5, 2001 (SE) 0103326-5

(51) Int. Cl. F16L 55/00; F16L 55/18

(52) U.S. Cl. 285/15; 285/133.11

(57) ABSTRACT

A first tube (1) is axially slitted (2) in order to be elastically compressible. The end portion of the first tube (1) has exterior convexly curved engagement formations (3) on the tube tubs formed by the slit (2). The tube tubs (11) can be elastically compressed in order to be introduced through a fitting mantle opening (8) in a second tube element (7). The opening (8) has a width, which is less than the inner diameter of the second tube element (7), and thereby defines internal engagement formations which cooperate with the external engagement formations (3) on the first tube element (1). The tube elements (1, 7) can simply be connected and detached by elastic compression of the tube tubs (11) and axial displacement of the first tube element (1).

The invention refers to a system for detachable connection of a first and a second tube element, of the kind revealed in the preamble of claim 1.

It is previously known to coaxially connect two tube elements by providing an end portion of a first tubular element with an axial slit, and after deformation of this end portion towards elimination of the slit, to introduce this end portion co-axially into an end portion of the second tube element, so that the first element after release, expands to engage the inner surface of the second tube element. By providing the exterior surface of the first tube and the interior surface of the second tube, with barb-like cooperation formations, a withdrawal of the first element from the second is prevented or made more difficult, and moreover, an axial insertion of the first element into the second is simplified thereby. By radially compressing the end portion of the first tube, the first tube can then be withdrawn from the second tube. A prerequisite is that the axial slit has an axial length which is substantially longer than the over-lap between the two tube elements. Such a connection system is previously known from U.S. Pat. No. 5,319,901, as an example.

A disadvantage with the known system is, however, that the connection between the straight tube elements is only of a coaxial nature and that the cooperation formations of the tube elements are difficult to provide.

An object of the invention is therefore to provide a connection system which provides releasable connection of two tube elements which join to each other with intersecting axes, said system being simplified with regard to the cooperation formations.

The object is fully or partially achieved by the invention.

The invention is defined in the appended claim 1.

Embodiments of the inventive system are stated in the enclosed dependent claims.

The connection between the two tube elements is stable, can easily be established and can easily be separated, and moreover, the two tube elements can be designed in order to establish a predetermined angle between the two tube elements as connected. The angle can be chosen to 30°, 45°, 60° or 90°, for example.

The inventive system is therefore well suited for speedy assembly of grid constructions, which comprise straight tubular elements to be joined.

In the following, the invention will be described in the form of an example, with reference to the enclosed drawing.

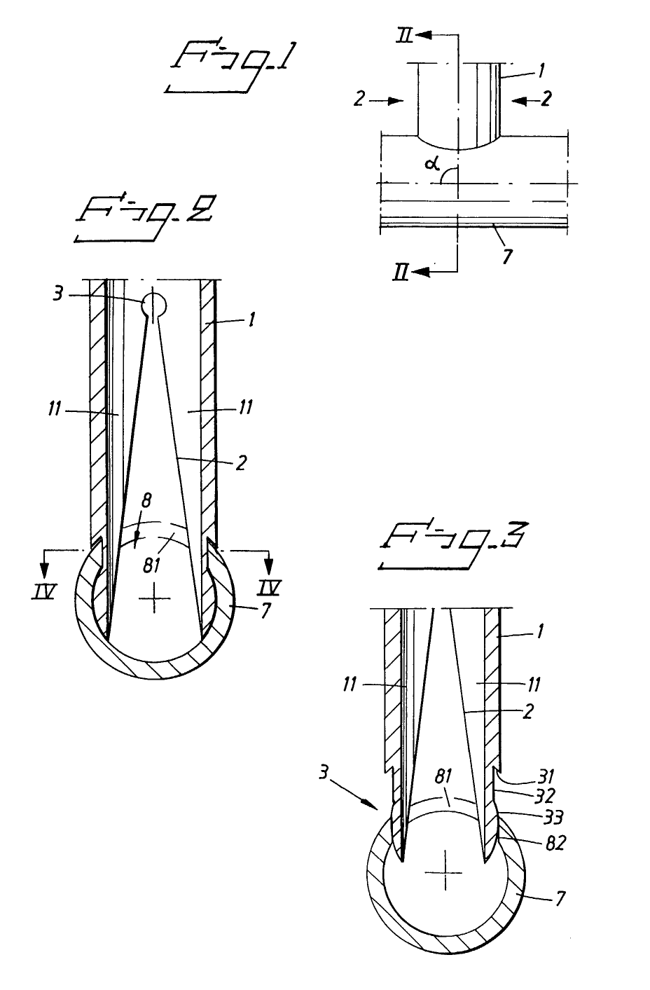

FIG. 1 schematically shows a side view of a system according to the invention, in connected condition.

FIG. 2 shows a section taken along line II-II in FIG. 1.

FIG. 3 shows the tubular components of the system during connection or separation, in a view corresponding to FIG. 2.

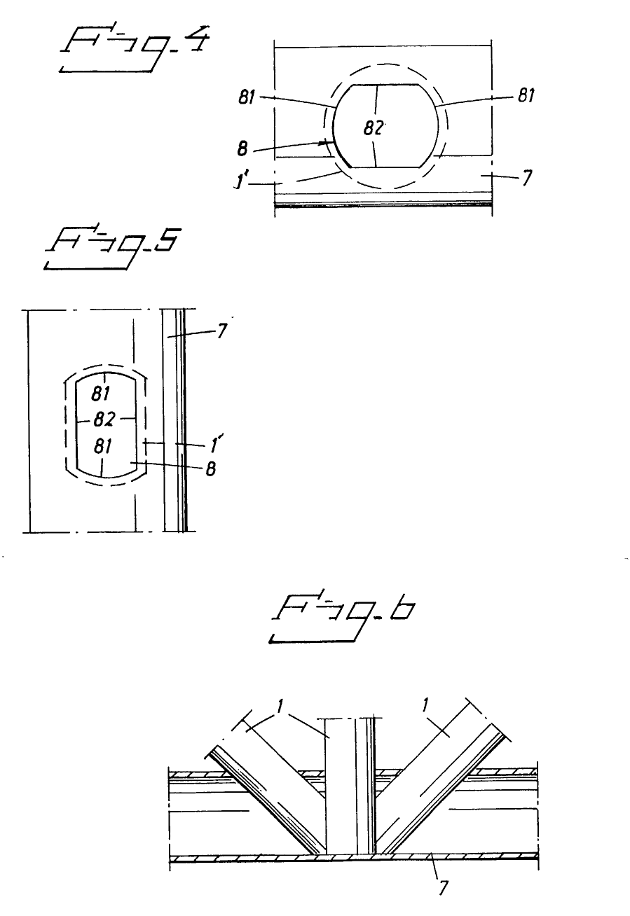

FIG. 4 shows a mantle opening in one of the tube elements.

FIG. 5 shows the mantle opening in one of the elements, when they form an oblique angle to each other.

FIG. 6 shows in a schematic cross section a node, at which several transverse tubular elements connect to a longitudinal tube element.

The inventive system comprises two tube elements 1, 7, which can be releasably connected thereby that the end portion 3 of the first tube element 1 is threaded through a mantle opening 8 in the second tube element 7. In the embodiment the cooperating parts of the tube elements 1, 7 are designed to provide a stable connection when the axes of the tube elements 1, 7 form an angle α (FIG. 1), which is 90°. However, it should be noted that the angle α can be varied in range from about 20° to about 160° while maintaining the inventive principles.

Tubes 1, 7 are circular cylindrical. The first tube element/tube 1 has an axial slit 2, which is widening toward the connection end of the tube 1. The slit 2 converges toward the circular opening 3 through the wall of the tube 1. The slit 2 has a substantial length in order to permit the resulting opposing tube tubs 11 to be deformed elastically in direction toward each other.

The exterior diameter of tube 1 is larger than or equal to the inner diameter of tube 7.

The drawing reveals that the tube 1 is outwardly provided, on opposing sides, with a straight waist 32, extending transversally, which receives the adjacent straight edge 82 of the opening 8, the waist 32 being upwardly limited by a shoulder 31, which will rest against the tube 7 around the opening 8. FIG. 4 shows the exterior perimeter of the tube 1 with a dashed line 1 at the exterior surface of tube 7.

FIGS. 2 and 3 reveal that the end portion of tube 1 has outwardly been formed into a contour which closely connects to the inner circumference of tube 7, when the end portion 3 of tube 1 has been inserted therein.

The corresponding arching portions 33 on the free end portions of the tube tubs 11 thus have convex exterior surfaces.

The opening 8 has rounded edge portions 81 (FIG. 4), which engage the rounded end portions of the formations 3. The edge portions 82 of the opening 8 are straight and parallel to the axis of tube 7 and receives the corresponding waists 32.

FIG. 3 reveals that the arched portions 33 taper toward their free ends, so that they provide a wedging action when the tube 1 is to be threaded through the opening 8. Thanks to this wedging action, the connection and the disconnection of the tubes 1, 7 are simplified, and, moreover, the demand on elastic compression of the tube tubs 11 is diminished.

A marked sharp transition can be provided between the waist 32 and the arched portion 33 in order to obstruct a withdrawal of the tube 1 without preceding compression of the parts 11 towards each other. When a particularly stable connection between the tubes 1, 7 is required, a spacer element can be threaded through the slit 2, i.e. through two opposite wall slits 2 of the tube 1, for example, outside the exterior circumference of the tube 7.

As mentioned, the inventive system can be designed for another angle α and then the opening 8 and the end portion of tube 1 must be given a corresponding modification, which the artsman can provide by geometrical considerations, for example, by corresponding oblique projections of the cooperation parts of tubes 1-7. The tube parts which are connected, can constitute longitudinal or transverse elements in truss beams, for example, flat framework beams, or truss beams with a polygonal cross-section, where each polygon corner as an example is formed by a longitudinal element 7.

When the elements, especially the longitudinal elements 7, have an excellent bending flexibility, the truss beam can be formed thereby that the transverse elements are successively snapped into the longitudinal elements 7, which are held bent apart, while the respective transverse element is connected between them. The inventive connection can be used preferably and, as an example, together with the tube elements 1, 7 of fiber reinforced plastics.

Moreover, such truss beams can be formed thereby that a group consisting of two or three transverse elements 1 are jointed to a longitudinal element 7 in a node, as is illustrated on FIG. 6, so that the transverse elements 1 form different angles to the longitudinal element 7. The elements 1 of the node can support against each other in the element 7. At a node, the longitudinal element 7 can have a longitudinally extended wall opening, which receives all the transverse elements of the node, but for stability reasons, the tubes 1 of the node can have separate associated mantle openings in the tube 7, which are thus separate from each other.

FIG. 5 shows schematically a variant of FIG. 4 for the situation that the angle α (FIG. 1) is oblique, for example 45°.

1. A system for detachable connection of a first and a second tube element, comprising a first tube element, which in one end portion thereof has an axial slit through opposed wall portions of the tube element, said slit (2) widening toward the free end of the first tube element (1), a second tube element (7) having an opening (8), into which the slitted end portion of the first tube element can be inserted after elastic compression across the slit, the end portion of the first tube element having exterior engagement formations (33), the second tube element (7) having interior engagement formations, which are assigned to engage the engagement formation of the first tube element (1) after release of the elastic compression of the first tube element 1, characterized in that the opening (8) of the second tube element (7) is arranged through the mantle wall of the second tube element (7), in that the mantle wall opening (8) has a width which, in the longitudinal direction of the second tube element, is less than the inner diameter of the second tube, so that the inner circumference of the second tube (7) forms said engagement formation, in that the end portion of the first tube (1) is shaped in an axial plane, which is perpendicular to extension plane of the slit (2), in order to solidly support against the interior engagement formation of the second tube element (7), and in that opposite parts of this end portion of the first element, which face away from each other, form the exterior engagement formation (3).

2. A system according to claim 1, wherein the end portion of the first tube element (1) has a waist (32), which receives the edge (81) of the mantle opening (8).

3. A system according to claim 1 or 2, characterized in that the first and the second tube element has central axes and in that the axes of the tube elements (1, 7) as joined intersect at an angle α in the range 20-160°.

4. A system according to any of the preceding claims, wherein the end portion of the first tube element has, in an axial plane which is perpendicular to the axis of the second tube, an exterior contour, which joins to the inner wall of the second tube.

5. A system according to claim 4, characterized in that the mantle opening (8) has a width, across the axis of the second tube (7), which is less than the exterior diameter of the first tube (1).

6. A system according to any of claims 1-5, characterized in that the opening (8) has a length, in the axial direction of the second tube (7), which is adapted to the corresponding length of the engagement formations (3) of the first tube elements (1), and wherein the mantle wall opening (8) is formed to prevent the first tube element (1) to turn around the axis thereof.

7. A system according to any of claims 1-6, wherein the tube elements (1, 7) are circular cylindrical.

8. A system according to any of claims 1-7, wherein the engagement formations (3) of the first tube element are formed by machining of the end portion of the first tube element.

9. A system according to any preceding claim, wherein the exterior diameter of the engagement formations of the first tube element (1) are, in the unloaded condition of the first tube element (1), larger than or equal to the inner diameter of the second tube element (7).

10. A system according to claim 9, wherein the outer diameter of the exterior engagement formations on the tube (1) are, in the unloaded condition of the tube element (1), larger than the inner diameter of the second tube element.
